(19) United States
(12) Patent Application Publication
(10) Pub. No.: US 2003/0211947 A1
(43) Pub. Date: Nov. 13, 2003

(54) Hybrid superconductor technology filter

(76) Inventor: Amr Abdelmonem, Northbrook, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/140,969

(22) Filed: May 8, 2002

(51) Int. Cl. H01P 1/20; H01B 12/02

(52) U.S. Cl. 505/210; 333/99 S

(57) ABSTRACT

A superconducting electromagnetic filter arrangement uses two filters, one of which is fabricated from thin film high temperature superconductor (HTS) material and one of which is fabricated from thick film HTS material. Using both thick and thin film technologies exploits the advantages of each technology. The thick film HTS filter may be fabricated from conventional thick film materials or may be fabricated from all temperature performance (ATP) materials that allow the thick film filter to work at super-critical temperatures.

### TECHNICAL FIELD

The present invention pertains to electromagnetic filters and, more particularly, to hybrid superconductor filter arrangements utilizing both thick and thin film superconductor technology.

### BACKGROUND

The advantages of using superconductor technologies in the field of electronic communications are well known. For example, resonators and filters fabricated from high temperature superconductor (HTS) materials have extremely low loss characteristics when they are operated below the critical temperature of the superconductor material, which is roughly 77° K. The low loss characteristics of superconductor filters and resonators enable such devices to have extremely high quality factors (Q's). For example, an HTS filter, which includes a number of HTS resonators, may have a Q on the order of 20,000. As will be readily appreciated, filters with high Q's are very useful in communications applications such as, for example, cellular telephone networks in which channels may be very closely spaced. The steep slopes of the HTS filter skirts prevent interference between closely spaced channels, thereby allowing cellular carriers to more densely pack their expensive bandwidth with subscriber calls.

HTS technology for communications applications has largely evolved along two different technological lines—thin film superconductor technology and thick film superconductor technology. As described below, each of these technologies has its advantages and its drawbacks.

Thick film filters typically include a substrate, which may be, for example, plated or unplated stainless steel or a ceramic material such as alumina or the like, and may be formed into rod, spiral or slotted-spiral shapes. A layer of HTS material such as, for example, Yttrium-Barium-Copper Oxide (YBCO) that may be mixed with silver or some other conductive material, is then deposited onto the substrate. The substrate and the HTS material are then processed to yield a superconducting resonant structure having a particular resonant frequency.

Thick film HTS technology filters may be relatively large in size in comparison to thin film HTS technology filters, which are be described below. One of the benefits, however, of the size of the thick film HTS filters is that such filters are capable of handling more power than thin film filters and have more stable temperature performance than thin film filters. As is well known, temperature stability is highly desirable in HTS filters because stable HTS filters have response corners (i.e., locations in the frequency response of the filter that lie between the passband and the skirt of the response) that do not vary widely under temperature variations in which the filter is operated. Temperature stability increases the ease with which HTS filters may be designed because the response corners will not move drastically with temperature.

Thin film HTS filters, as opposed to thick film HTS filters, have relatively small sizes, thereby allowing many filter poles to be disposed within a small volume. Accordingly, on a per-volume basis, thin film HTS filters contain many more poles than thick film HTS filters. Typically, as noted above, thin film HTS filter are more temperature sensitive than thick film HTS filters. Accordingly, because the response corners of thin film HTS filters may move considerably with temperature variations, it may be difficult to design thin film HTS filters having optimal Q and passband characteristics because thin film HTS filters must be designed with margins that allow for the variation in the passband with changes in temperature.

### BRIEF DESCRIPTION OF THE DRAWINGS

FIG. 1 is an exemplary drawing of a cooled filter arrangement;

FIG. 2 is an exemplary diagram of a first filter arrangement;

FIG. 3 is an exemplary diagram of a second filter arrangement;

FIG. 4 is an exemplary diagram of a frequency response of the filter configuration of FIG. 3 using an all temperature performance (ATP) HTS thick film filter;

FIG. 5 is an exemplary diagram of a frequency response of the filter configuration of FIG. 3 using a non-ATP HTS thick film filter; and

FIG. 6 is an exemplary diagram of a third filter arrangement.

### DETAILED DESCRIPTION

As described below, filter arrangements including both thin and thick film HTS technologies provide the benefits of each technology. Various arrangements are disclosed herein and others are contemplated, it being understood that the embodiments disclosed herein are merely exemplary and that the scope of protection of this patent is defined by the claims appended hereto.

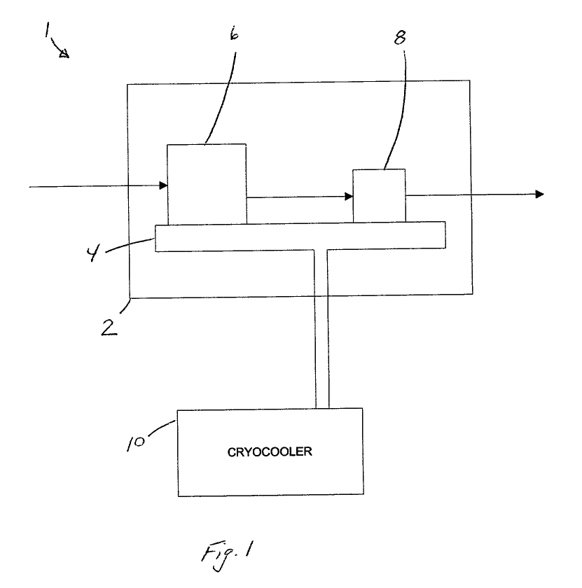

Referring to FIG. 1, an exemplary cooled filter arrangement 1 may include a cryostat 2 in which a cold finger 4 may extend. First and second filter elements 6, 8 are disposed within the cryostat 2 and mounted to the cold finger 4. As described below in detail, the first and second filter elements 6, 8 may be embodied in HTS thick or thin film filters, which may optionally have ATP characteristics that allow the filters to operate at super-critical temperatures. Additionally, the filter elements 6, 8 may have other circuit elements or devices such as low noise amplifiers (LNAs), circulators or the like integrated therewith. A cryocooler 10 cools the cold finger 4, which, in turn, cools the filter elements 6, 8. The cryocooler 10 may be embodied in a Stirling cooler that is commercially available from Leybold Vakuum of Cologne, Germany or from any other suitable supplier.

In operation, the first filter element 6 may receive input signals from, for example, a base station cell site antenna or the like. After filtering the received signals, the first filter element 6 couples the filtered signals to the second filter element 8, which further filters the filtered signals. The output of the second filter element 8 may be coupled to other known or presently unknown circuits or devices that process the output of the second filter element 8 to, for example, process cellular communications or the like.

As shown in FIG. 2, the first and second filter elements 6, 8 may be embodied in thick and thin film HTS filters 20, 22 that are disposed within the cryostat 2. A number of optional bypass paths 24, 26 may be used to selectively bypass one of more of the filters 20, 22. It should be noted that the bypass paths 24, 26 are optional and one or the other of the bypass paths 24, 26 may be used in the configuration of FIG. 2. The bypass paths 24, 26 may be switched in and out of the circuit by, for example, double pole, double throw switches.

A first switch or relay 28, the individual poles of which are represented by reference numerals 28A and 28B, may be coupled between the input and the output to the cryostat 2, thereby enabling bypassing of both the thick film HTS filter 20 and the thin film HTS filter 22. A second switch or relay 30, the individual poles of which are represented by reference numerals 30A and 30B, may be coupled to an input to the thin film HTS filter 22 and to an output of the thin film HTS filter 22, thereby enabling bypassing of the thin film HTS filter 22. The switches 28 and 30 are optional based on the number of bypass paths used and may be controlled by a processing device programmed to monitor the cryostat temperature and to change the state of the switches 28 and 30 to bypass certain components when the temperature within the cryostat indicates that certain ones of the devices contained therein may be operating at a temperature that is above their critical superconducting temperature.

In practice, the switches 28 and 30 may be embodied double pole, double throw devices. Alternatively, the switches 28, 30 may be embodied in single pole, double throw devices that are used in pairs. For example, the switches may be embodied in devices that are commercially available from Sage, Dow-Key Microwave, Aromat or from any other suitable microwave switch or relay provider. In particular, the switches 28, 30 may be embodied in an Aromat Relay bearing model number ARX 1003.

The cryostat 2, as well as the thick and thin film HTS filters may be embodied in components that are commercially available from, for example, ISCO International, Inc. of Mt. Prospect, Ill. Additional detail on the fabrication and use of the thick and thin film HTS filters 20, 22 may be found in U.S. patent application Ser. No. 09/874,725 (“A Dual Operation Mode All Temperature Filter Using Superconducting Resonators”) and Ser. No. 09/130,274 (“RF Receiver Having Cascaded Filters and an Intermediate Amplifier Stage”) and in U.S. Pat. No. 6,208,227 (“Electromagnetic Resonator”) and U.S. Pat. No. 6,122,533 (“Superconductive Planar Radio Frequency Filter Having Resonators with Folded Legs”), all of which are expressly incorporated herein by reference.

In operation, when neither of the HTS filters 20, 22 is being bypassed, input signals are coupled to the thick film HTS filter 20 through the pole 28A. The thick film HTS filter 20 may be embodied in a bandpass filter having a center frequency near 1950 megahertz (MHz), a passband on the order of 20 MHz and very high out of band rejection. The thick film HTS filter 20 filters the input signal and produces an output signal that is coupled to the thin film HTS filter 22 via the pole 30A. Like the thick film HTS filter 20, the thin film HTS filter 22 is a bandpass filter having a relatively narrow passband and high out of band rejection. The output of the thin film filter 22 is coupled from the cryostat 2 via the poles 30B and 28B.

As will be readily appreciated, because the HTS filters 20, 22 are superconducting components that must be cooled, a rise in ambient temperature within the cryostat 2 may cause one or both of the HTS filters 20, 22 to suffer performance degradation or operational failure. To minimize the effects of such degradation or failure, the optional bypass paths 24, 26 may be used in conjunction with the switches 28, 30 to bypass one or more of the HTS filters 20, 22. For example, if both of the thick film HTS filter 20 and the thin film HTS filter 22 are non-ATP devices, a temperature rise within the cryostat 2 may cause the poles 28A and 28B of the switch 28 to couple the input signal through the bypass path 24 to eliminate a failed or degraded path through the HTS filters 20, 22. Alternatively, if the thick film HTS filter 20 is made using an ATP design, a rise in temperature may only necessitate the bypassing of the thin film HTS filter 22 via the poles 30A and 30B of the switch 30 in conjunction with the bypass path 26.

With respect to the embodiment shown in FIG. 2, the center frequencies of the HTS filters 20, 22 may be similar or nearly identical. The bandwidths of the HTS filters 20, 22 may be, for example, within 5% of one another. Additionally, the effect of loading between the HTS filters 20, 22 must be evaluated. Conventional filter design methods assume a 50 ohm output impedance coupled to a filter. This design process can be followed when each filter is designed separately. However, for cases in which two HTS filters 20, 22 are connected to one another, iteration in the design process is needed so that each filter is optimized to account for the imperfect match expected with HTS filters. For example, the thick film HTS filter 20 does not present a 50 ohm output impedance to the thin film HTS filter 22 and the input impedance of the thin film HTS filter 22 is not 50 ohms. Accordingly, numeric optimization is needed to solve for both filter parameters simultaneously using conventional design techniques as a starting point.

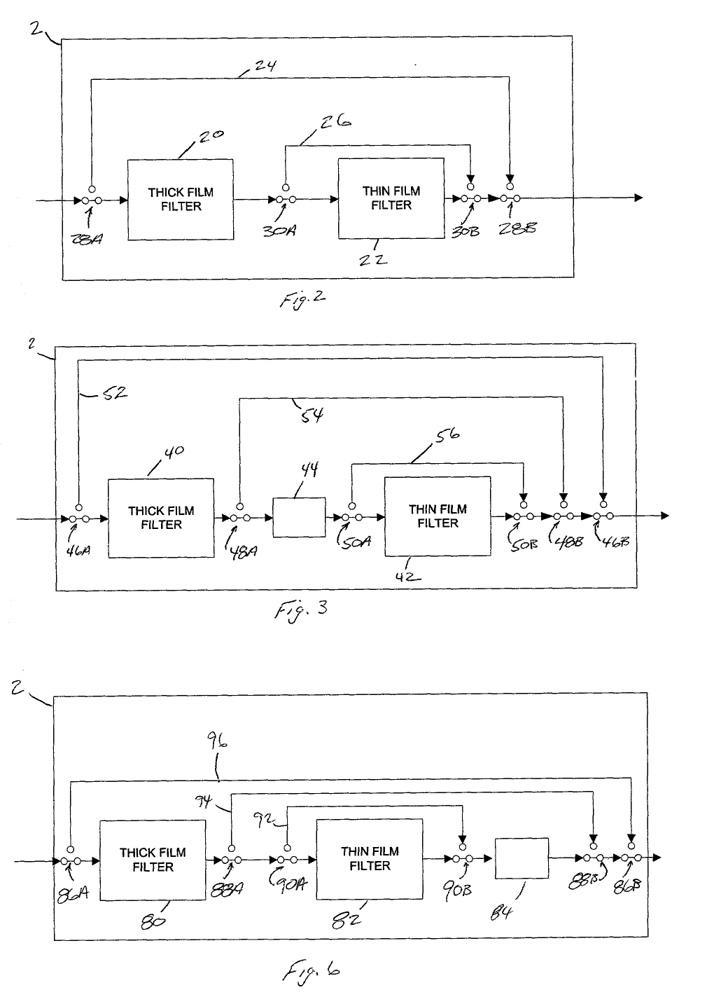

Turning now to FIG. 3, a second configuration may include not only a thick film HTS filter 40 and a thin film HTS filter 42, but a decoupling device 44, a number of optional switches 46, 48, and 50 having poles 46A and B, 48A and B and 50A and B, respectively. The switches 46-50 may be embodied in double pole, double throw switches or in pairs of single pole, double throw switches that are coupled to and a number of optional bypass paths 52-56, respectively. Again, some, none or all of the switches 46-50 and bypass paths 52-56 may be used.

The decoupling device 44 may be embodied in, for example, any non-reciprocal device such as an LNA, a circulator, an isolator or any other suitable device that is easily impedance matched to the output of the thin film HTS filter 40 and the input of the thick film HTS filter 42. The decoupling device 44 may be integrated with one or the other of the thick film HTS filter 40 or the thin film HTS filter 42 or may be a separate component therefrom. As described in conjunction with FIG. 2, the switches 46-50 of FIG. 3, along with the bypass paths 52-56 may be used to bypass various ones of the thick film HTS filter 40, the thin film HTS filter 42 and the decoupling device 44 as well as the thin film HTS filter 42. Again, the switches may be controlled by a processing device that monitors the temperature inside the cryostat 2.

As noted with respect to FIG. 2, the bypass paths 52-56 shown in FIG. 3 are optional. For example, if the thick film HTS filter 40 is an ATP filter, it may be unnecessary to bypass it, so the bypass 52 could be omitted.

As shown in FIG. 4, a frequency response plot 60 shows the frequency responses of the thick film HTS filter 40, the thin film HTS filter 42 as lines 62 and 64, respectively. The combined response including both the thick film HTS filter 40 and the thin film HTS filter 42 when no bypassing is used is shown as line 66 on the frequency response plot 60. To create the frequency response plot 60 of FIG. 4, the thick film HTS filter 40 was embodied in a 10-pole ATP filter and the thin film HTS filter 42 was embodied in a 16-pole HTS filter. The frequency response of the thick film HTS filter 40 (line 62) is wider than that of the thin film HTS filter 42 (line 64) because the thick film HTS filter 40 has a lower Q value and, therefore, has more rounded frequency response corners that those of the thin film HTS filter 40. In such an embodiment, the thin film HTS filter 42 defines the corners of the combined response (line 66) and the thick film HTS filter 40 is used to steepen the slope of the skirts of the combined response.

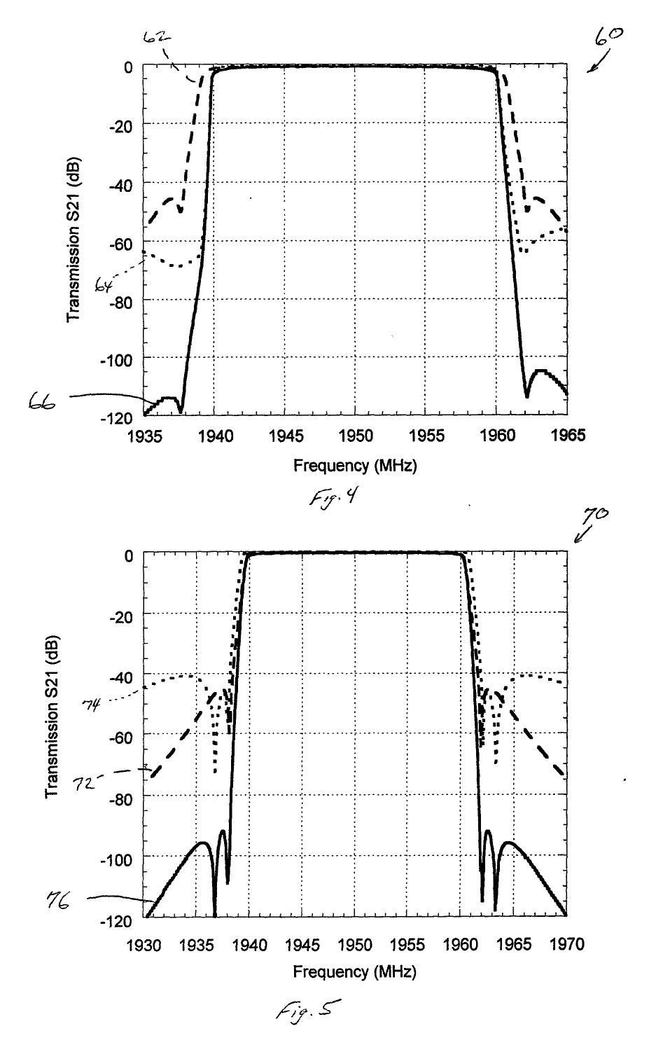

FIG. 5 is a frequency response plot 70 of a non-ATP configuration of the arrangement shown in FIG. 3. In FIG. 5, the lines 72 and 74 represent the frequency responses of the thick and thin film HTS filters 40, 42, respectively, and the line 76 represents the cascaded response of the filters without bypassing. To create the frequency response plot 70, the thick film HTS filter 40 was embodied in a 10-pole non-ATP filter and the thin film HTS filter 42 was embodied in an 8-pole thin film filter. The thin film filter response (line 74) has a wider passband than the thick film response (line 72) because the thick film HTS filter 40 is more stable and can be relied upon to precisely locate the corners of the cascaded response (line 76). The thin film HTS filter 42 is used to double the rejection provided by the thick film HTS filter 40, while not adding a significant amount of size to the circuit.

Another filtering configuration is shown in FIG. 6, wherein a thick and thin film HTS filters 80 and 82 are coupled to one another and the thin film HTS filter 82 is further coupled to an output device 84, which may be embodied in an LNA or any other suitable device that may be integrated with or apart from the thin film HTS filter 82. As with the prior arrangement, the arrangement of FIG. 6 includes switches 86, 88 and 90, which have poles 86A and B, 88A and B and 90A and B, respectively. The switches 86-90 may be double pole, double throw switches used to bypass various ones of the components 80-84 via the bypass paths 92-96. Alternatively, the switches 86-90 could be embodied in pairs of single pole, double throw switches.

Although each of the arrangements shown in FIGS. 2, 3 and 6 is shown as the thick film HTS filter having its output coupled to the input of a thin film HTS filter, this need not be the case. However, in certain power handling applications, it may be more desirable to have the thick and thin film HTS filters arranged as shown in the drawings. Additionally, while a number of bypass paths and switches are shown in FIGS. 2, 3 and 6, it should be noted that some none or all of the bypass paths and switches shown may be used. Alternatively, other bypass paths than those shown may be used. Furthermore, any of the configurations of FIGS. 2, 3 and 6 could be used in a duplexed configuration in which the input of the thick film HTS filter is provided by a duplexer output. In such situations, the duplexer could be disposed within the cryostat 2 or outside of the cryostat 2.

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A high temperature superconductor (HTS) electromagnetic filter arrangement, comprising:
a thick film HTS filter having an input and an output; and
a thin film HTS filter having an input and an output, wherein the input of the thin film HTS filter is coupled to the output of the thick film HTS filter.

2. The HTS electromagnetic filter arrangement of claim 1, wherein the thick film HTS filter comprises an all temperature performance thick film HTS filter.

3. The HTS electromagnetic filter arrangement of claim 2, further comprising a bypass path adapted to couple the input of the thick film HTS filter to the output of the thin film HTS filter when an operational temperature of the thin film HTS filter exceeds a critical temperature of the thin film HTS filter.

4. The HTS electromagnetic filter arrangement of claim 3, further comprising an amplifier coupled to the output of the thin film HTS filter.

5. The HTS electromagnetic filter arrangement of claim 1, wherein the thick film HTS filter is directly coupled to the thin film HTS filter.

6. The HTS electromagnetic filter arrangement of claim 1, further comprising a decoupling device coupled between the output of the thick film HTS filter and the input of the thin film HTS filter.

7. The HTS electromagnetic filter arrangement of claim 6, wherein the decoupling device comprises an amplifier.

8. The HTS electromagnetic filter arrangement of claim 6, wherein the decoupling device comprises a circulator.

9. The HTS electromagnetic filter arrangement of claim 1, further comprising an amplifier having an input and an output, wherein the input of the amplifier is coupled to the output of the thin film HTS filter.

10. The HTS electromagnetic filter arrangement of claim 9, further comprising a bypass path adapted to couple the input of the thin film HTS filter to the output of the amplifier.

11. The HTS electromagnetic filter arrangement of claim 1, further comprising a bypass path adapted to couple the input of the thin film HTS filter to the output of the thin film HTS filter when an operational temperature of the thin film HTS filter exceeds a critical temperature of the HTS filter.

12. The HTS electromagnetic filter arrangement of claim 1, further comprising a bypass path adapted to couple the input of the thick film HTS filter to the output of the thin film HTS filter when operational temperatures of one of the thick film HTS filter and the thin film HTS filter exceeds critical temperatures of the one of the thick film HTS filter and the thin film HTS filter.

13. A high temperature superconductor (HTS) electromagnetic filter arrangement, comprising:
a cryostat;
a thick film HTS filter disposed within the cryostat, wherein the thick film HTS filter has an input and an output; and
a thin film HTS filter disposed within the cryostat, wherein the thin film HTS filter has an input and an output, wherein the thin film HTS filter is coupled to the thick film HTS filter.

14. The HTS electromagnetic filter arrangement of claim 13, wherein the output of the thick film HTS filter is coupled to the input of the thin film HTS filter.

15. The HTS electromagnetic filter arrangement of claim 13, wherein the thick film HTS filter comprises an all temperature performance (ATP) thick film HTS filter.

16. The HTS electromagnetic filter arrangement of claim 13, further comprising a decoupling device coupled between the thick film HTS filter and the thin film HTS filter.

17. The HTS electromagnetic filter arrangement of claim 13, wherein the thick film HTS filter is directly coupled to the thin film HTS filter.

18. The HTS electromagnetic filter arrangement of claim 13, further comprising a bypass path for bypassing one of the thick film HTS filter and the thin film HTS filter.

19. The HTS electromagnetic filter arrangement of claim 13, further comprising a bypass path for bypassing the thick film HTS filter and the thin film HTS filter.

20. A high temperature superconductor (HTS) electromagnetic filter arrangement, comprising:
a cryostat;
a thick film all temperature performance (ATP) HTS filter disposed within the cryostat, wherein the thick film HTS filter has an input and an output;
an amplifier disposed within the cryostat and coupled to the thick film ATP HTS filter; and
a thin film HTS filter disposed within the cryostat, wherein the thin film HTS filter has an input and an output and wherein and the thin film HTS filter is coupled to the amplifier.

21. The HTS electromagnetic filter arrangement of claim 20, further comprising a bypass path disposed within the cryostat and a switch having a first pole disposed within the cryostat and coupled to the output of the thick film ATP HTS filter and to the bypass path and having a second pole disposed within the cryostat and coupled to the output of the thin film HTS filter and to the bypass path.

22. The HTS electromagnetic filter arrangement of claim 21, wherein the switch is controlled to change positions of each of the poles when a temperature within the cryostat reaches a predetermined temperature.

23. The HTS electromagnetic filter arrangement of claim 22, wherein the predetermined temperature is a temperature above a critical temperature of the thin film HTS filter.
